(19) United States
(12) Patent Application Publication
(10) Pub. No.: US 2026/0179070 A1
(43) Pub. Date: Jun. 25, 2026

(54) SERVICE-AGNOSTIC POLICY ENFORCEMENT CONTROL ENGINE

(71) Applicant: STRIPE, INC., South San Francisco, CA (US)

(72) Inventors: Rishabh Jain, San Francisco, CA (US); Michael Bauer, Brooklyn, NY (US); Assaf Sternberg, Richmond, VA (US); Penghuan Ni, Redmond, WA (US); Kriti Shah, San Jose, CA (US); Robert Ying, Mercer Island, WA (US); Jeremiah John Clemenson, Boulder, CO (US)

(21) Appl. No.: 18/988,707

(22) Filed: Dec. 19, 2024

(51) Int. Cl. G06Q 20/12; H04L 9/40

(52) U.S. Cl. CPC G06Q 20/1235; H04L 63/20; G06Q 2220/18; H04L 2463/101

(57) ABSTRACT

A method of service-agnostic policy enforcement includes receiving a first request comprising information in a non-standardized format and converting the information into a data package comprising a plurality of attributes in a standardized format. An orchestrator receives a second request comprising the data package to generate a license token for executing an action. The orchestrator invokes a policy-based controls engine to validate the second request. The controls engine identifies one or more policies applicable to the second request based on one or more of the plurality of attributes in the data package. The policies are implemented as computational constraint expressions. The controls engine validates the second request based on the attributes satisfying each of the constraint expressions. The method further includes generating the license token based on successful validation of the second request and executing the action using the license token.

### BACKGROUND

Modern technologies have made it possible for e-commerce to take place around the globe across different geographical locations, jurisdictions, languages, currencies, and product sectors. In particular, application programming interface (API) enabled payment gateway and processing technology provides merchants of all sizes the ability to conduct e-commerce activities in a trusted, secure, and compliant manner, streamlining what would otherwise be a complex technological endeavor.

The above information disclosed in this Background section is only for enhancement of understanding of the present disclosure, and therefore it may contain information that does not form the prior art that is already known to a person of ordinary skill in the art.

### SUMMARY

The present disclosure is directed to service-agnostic policy enforcement for API-enabled payment processing technology, substantially as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 depicts a computing environment, according to one or more embodiments of the present disclosure.

FIG. 1A depicts a computing environment of an e-commerce network with service-agnostic policy enforcement, according to one or more embodiments of the present disclosure.

FIG. 2 depicts a computing environment with service-agnostic policy enforcement, according to one or more embodiments of the present disclosure.

FIG. 3 depicts a flowchart of a first method for service-agnostic policy enforcement, according to one embodiment of the present disclosure.

FIG. 4 depicts a flowchart of a second method for service-agnostic policy enforcement, according to one embodiment of the present disclosure.

FIG. 5 depicts a flowchart of a third method for service-agnostic policy enforcement, according to one embodiment of the present disclosure.

FIG. 6 is a block diagram illustrating a high-level network architecture of a computing system environment for operating a processing system according to embodiments of the present disclosure.

FIG. 7 is a block diagram illustrating a representative software architecture, which may be used in conjunction with various hardware architectures as described herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Modern technologies have made it possible for e-commerce to take place around the globe across different geographical locations, jurisdictions, languages, currencies, and product sectors. Application programming interface (API) enabled payment gateway and processing technology provides merchants of all sizes the ability to conduct e-commerce activities in a trusted, secure, and compliant manner, streamlining what would otherwise be a complex technological endeavor. As such technology becomes increasingly advanced, with different interested parties creating tools for enabling activities that were before not possible, many new technological challenges arise specifically from these technological developments. For example, the ability to efficiently facilitate transactions between parties across different geographical locations, jurisdictions, languages, currencies, and product sectors may come with challenges with respect to the multitude and ever-changing regulatory requirements that these transactions may be subject to. The regulatory landscape may be so large that it is beyond a merchant or payment processor's ability to monitor, detect, and/or enforce in real time. Adding to this challenge is the multitude of computing services (e.g., computer-implemented services/products) a payment processor may offer, each of which may have their own set of regulatory requirements across various locations, jurisdiction, currencies, and the like. Further complicating the matter is that these various computing services may have their own data consumption formats, which makes it difficult to update each service to comprehensively to adapt to and cover new or updated regulatory requirements across all potential transactions.

Some aspects of embodiments of the present disclosure relate to a centralized, service-agnostic control engine that automatically analyzes incoming requests in real-time to filter out and/or reject requests that do not meet one or more requirements that are applicable to the request.

For example, some aspects of embodiments of the present disclosure relate to a payment processing platform with a centralized, service-agnostic policy-based controls engine that automatically analyzes all transaction requests in real-time to filter out and reject requests that do not meet all the regulatory requirements that are applicable to the request. E-commerce transactions, such as checkouts, are expected to happen basically instantaneously, with both the buyer and the seller receiving confirmation of the transaction right away. Thus, in order to maintain the user experience, analysis of a transaction for regulatory compliance, and approval or rejection of the transaction should also happen basically instantaneously. It should be accomplished in a way that is an imperceptible part of the checkout process. This challenge arises directly from the nature of computing and internet technology. Further complicating the issue is that an unknown number of transactions may take place from any location at any time, often simultaneously, and all of these transactions must be analyzed in real time. Sometimes, there may be a sudden traffic spike which requires additional allocations of resources. For example, a merchant may be having a product launch or saleleading to a sharp increase in checkouts. A cloud-based, or distributed computing, environment is able to instantly allocate the computing resources needed to handle the analysis of each transaction for compliance without interrupting the user experience for the buyer or the seller. The present techniques provide a solution to these technical challenges. Specifically, in some embodiments, the policy-based controls engine is automatically invoked immediately upon receiving any request to transfer funds, so as to provide an automatic and near instantaneous validation of all fund transfer requests regardless of the originating computing service. This way, the validation process is an imperceptible part of the checkout process and the user experience is not degraded.

For example, in some embodiments, a merchant server may send, via API, a request to a computing service of a payment processing platform for a fund transfer to be executed. The request may include particular API parameters and information that is structured in a particular and non-standardized format with respect to other computing services of the payment processing platform. Thus, the request is converted into a data package that includes a plurality of attributes representing the information and presented in a standardized format (e.g., a homogeneous format rather than one of the heterogenous formats consumed by the different computing services). Thus, regardless of the type of computing service that is called, the relevant information (e.g., parameters, attributes) in the request is converted into the same standardized format for downstream processing by the computing service. The computing service may then call an orchestrator of the computing environment to generate a license token needed for executing the fund transfer. The call includes the data package generated by the computing service which includes a plurality of attributes in the standardized format. Before issuing a license token, the orchestrator makes a call to a policy-based controls engine to validate that the request meets or complies with all of the policies that it is subject to.

As a part of the validation process, the policy-based controls engine identifies, from a database of policies, all policies that are applicable to the request based on the attributes in the data package. For example, different policies may be applicable to fund transfers that are associated with different geography regions, jurisdictions, languages, currencies, product sections, among others, and in various combinations. The policy-based controls engine validates the request based on whether the plurality of attributes satisfy the policies that it is subject to. A license token is generated based on successful validation of the request, and an electronic fund transfer is executed using the license token, thus fulfilling the request to complete the fund transfer. If the attributes do not satisfy the applicable policies, then the request is denied and the fund transfer is not executed.

Approaches according to aspects of embodiments of the present disclosure improve the functioning of microservices architecture, by performing validation and policy enforcement at a single centralized controls engine that enforces, in a service-agnostic manner, complex policies across different microservices and products that have different API parameters and which consume information that is structured in various and non-standardized formats.

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

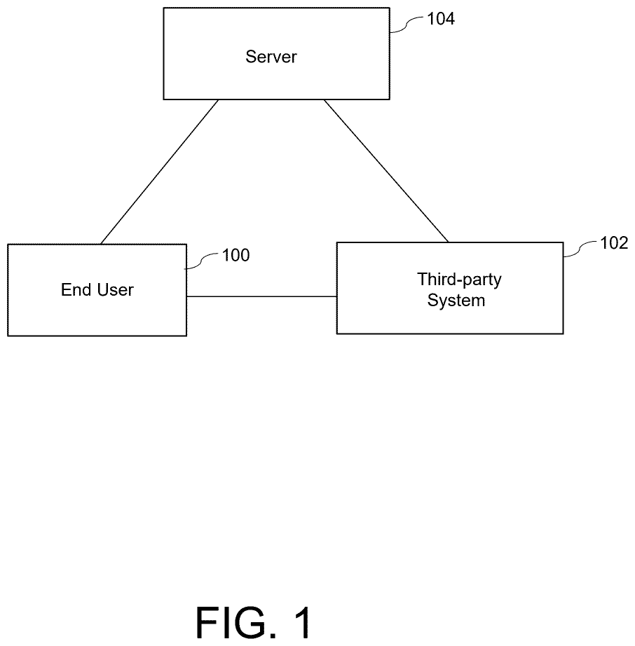

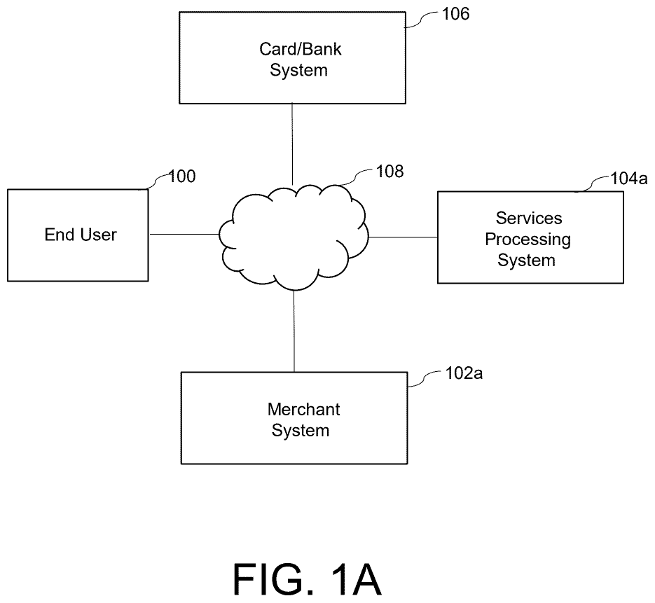

FIG. 1 depicts a computing environment in accordance with one or more embodiments. The computing environment includes an end user device 100, a third-party system 102, and a server 104, communicably coupled to one another over a data communications network 108. FIG. 1A depicts a computing environment with service-agnostic policy enforcement, according to one or more embodiments. The computing environment includes an end user device 100, merchant system 102, credit card or bank (collectively referred to as bank) system 106, and a services processing system 104 communicably coupled to one another over a data communications network 108. The data communications network 108 may be any wired or wireless local area network (LAN), private wide area network (WAN), and/or the public Internet. The merchant system 102, services processing system 104a, and bank system 106 may be hosted in a single server or distributed over multiple servers under the control of a single or multiple organizations. The end user device 100 may be a desktop, laptop, mobile device, smart phone, tablet, and/or any other computing device conventional in the art. A customer, potential customer, or other end user (collectively referenced as an end user) desiring to purchase goods or services from a merchant may access the merchant system 102 using the end user device 100.

The merchant system 102 may include one or more servers and/or computing devices. The servers and/or computing devices may include a processor and memory. The memory may include instructions that, when executed by the processor, cause the processor to provide merchant functionality as described herein. For example, the merchant system 102 may provide a web page or application that enables the end user to purchase goods and/or services (collectively referenced as products) sold by the merchant. In some embodiments, the merchant system 102 includes a point-of-sale (POS) terminal at a merchant location. The POS terminal may include a processor and memory. The memory may store instructions that cause the process to provide checkout functionality for products purchased by an end user from the merchant location. For example, the POS terminal may include software and hardware for accepting credit card information, forwarding the credit card information and associated purchase details to the services processing system 104a for approval, and displaying an indication as to whether the credit card has been approved or declined for the requested purchase amount.

In some embodiments, the merchant system 102 communicates with the services [0023] processing system 104a for processing payment for the products purchased by the end user (either online via the web page or application, or via the POS terminal). The merchant system 102 may collect the transaction information, such as, for example, customer information (e.g., name, shipping address, billing address, and the like), credit card information, purchase amount, and/or the like, and transmit the transaction information to the services processing system 104a.

The services processing system 104a may include a processor and a memory, where the memory includes instructions that cause the processor to provide transaction processing functionality described herein. The transaction processing functionality may include, for example, performing authentication and/or authorization, analyzing transactions for potential fraud, interacting with the bank system 106 for approving or declining the transactions, interacting with the merchant systems 102 for configuring merchant profiles, payment pages, and/or the like, and analyzing transaction requests with respect to one or more applicable control policies. The services processing system 104a provides payment methods, merchants, and their customers with improved experiences in processing electronic payments (e.g., electronic commerce over the internet). A given merchant seeking to accept payments from customers can integrate their computer systems with the electronic payment platform using one or more application programming interfaces (APIs) provided by that electronic payment platform. Such an integration may include, for example, including a user interface component in a checkout portion of an application or app and/or on a checkout web page of a website operated by the merchant. That merchant can then use the electronic payment platform to accept payments from customers. In more detail, the user interface component may provide a customer with options to pay using one or more different payment methods (e.g., credit card, debit card, bank account, or buy-now-pay-later). The customer may make the payment using one of these payment methods or, in some cases, the merchant may allow the customer to divide the payment across multiple payment methods (e.g., pay a portion of the total using a bank account and the remainder using a credit card). The electronic payment platform passes information collected through the user interface component to the payment methods to process the payments, such as transferring funds from a customer account and transferring those funds to a merchant account, and where the electronic payment platform and the payment processor (or payment processors) charge associated payment processing fees for the service.

In some embodiments, the bank system 106 may include software, hardware, and network interfaces for determining whether a credit card may be approved for a requested purchase amount. In this regard, the bank system 106 may check the credit card number, security code, credit limit, expiration date, and/or other information for approving or declining the purchase. The bank system 106 may also engage in its own analysis and assessment to approve or decline the transaction. If the credit card is approved, an approval message may be transmitted to the services processing system 104a which in turn may notify the merchant system 102 of the approval. The bank system 106 may also engage in the transfer of funds from the issuing bank to a recipient bank, in response to the credit card being approved.

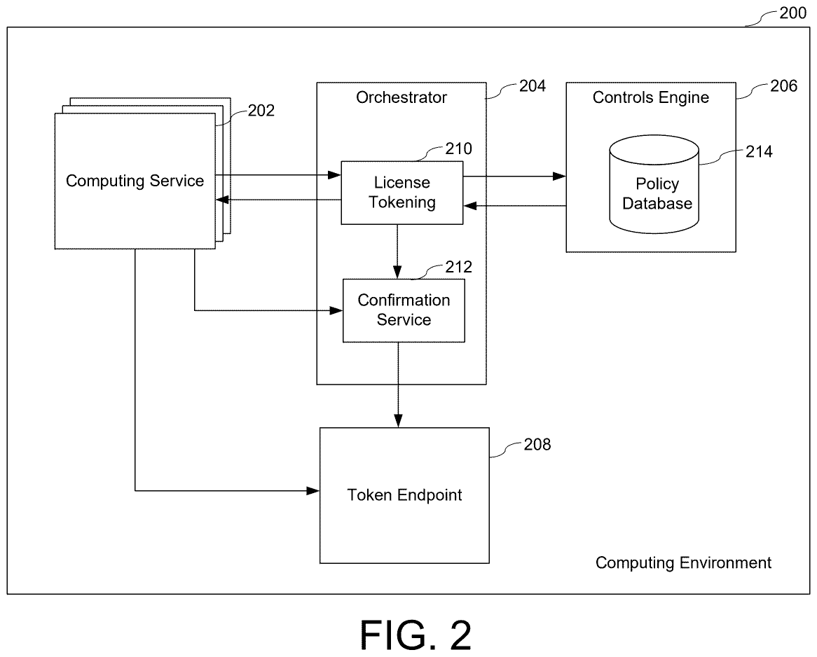

FIG. 2 is a block diagram illustrating a computing environment 200 of a services processing system 104a, in accordance with one or more embodiments. The computing environment 200 includes one or more computing services 202, an orchestrator 204, a controls engine 206, and a token end-point 208. In some embodiments, the token end-point 208 is a fund transfer manager. The computing environment 200 may include many other elements not illustrated herein for sake of focus and brevity. The one or more computing services 202 represent corresponding technology products offered by the services processing system 104a that may request fund transfer activities be performed by the fund transfer manager 208.

An example of a computing service 202 may include a hosted checkout function that enables merchants to collect payments without building out entire websites or hosting a payment gateway. Another example of a computing service 202 includes an integration that enables merchants to create a customizable checkout experience for collecting payments. Another example of a computing service 202 may provide automated recurring payment captures. Another example of a computing service 202 may enable merchant systems to integrate cryptocurrency payments and/or payouts into their e-commerce offerings.

Another example of a computing service 202 may include a multiparty integration service which can be used by merchant platforms such as double-sided e-commerce platforms, marketplaces, and software platforms to orchestrate transactions, route payments, and facilitate payouts between multiple parties (e.g., sellers, customers, service providers, and other entities.

Another example of a computing service 202 may include a banking as a Service (BaaS) API that enables merchant platforms to embed financial services on the into their platform software, which enables the merchant platforms to connected accounts to hold funds, pay bills, earn yield, manage cash flow, and the like. In some embodiments, the computing service 202 provides the infrastructure in partnership with trusted banks. Another example of a computing service 202 may include an API for issuing custom commercial payment cards and approving transactions in real time.

In some embodiments, a computing service 202 can be accessed by a merchant system 102 via the corresponding API. The APIs may be implemented as HTTP-based APIs such as RESTful and GraphQL, remote procedure call (RPC) APIs such as JSON-RPC, XML-RPC, SOAP, and gRPC, among others.

In some embodiments, a computing service 202 of the computing services may be accessed or called internally by another service, function, or orchestrator within the computing environment 200. Some computing services 202 may invoke other services and some services may be subcomponents of other services. In some embodiments, the computing services 202 may be implemented as microservices and the computing environment 200 may include a plurality of microservices for carrying out various combinations of computing tasks.

The orchestrator 204 may facilitate various operation flows within the computing environment 200 and/or between various computing services 202. For example, a computing service 202 may make a call to the orchestrator 204 to request a funds transfer be executed. The orchestrator 204 then invokes the controls engine 206 to validate or approve the request. In some embodiments, the controls engine 206 is a service-agnostic controls engine 206 that enforces policies in the same manner regardless of the service from which the request originates. In some embodiments, different computing services 202 receive information, such as from a merchant server via an API, in different formats. For example, the computing services 202 may have different API parameters and consume information that is structured in various and non-standardized formats with respect to other computing services 202 in the computing environment 200. For example, two different computing services 202 may use JSON documents to receive data, but may identify the same information (e.g., a timestamp) using different field (i.e., key) names (a single date and time field versus separate date and time fields) or may use different formats for representing the same information (e.g., local time, time zone, day, month, year versus a single value representing date and time based on universal coordinated time (UTC). In another example, a computing service 202 may utilize multiple JSON objects, in which relevant information needed for downstream processing by the controls engine 206 includes key-value pairs that are find in the multiple JSON objects, and which need to be extracted and restructured into a single object. Similarly, a computing service 202 may utilize a JSON array, in which values are listed in a particular order specific to that particular computing service 202. The computing service 202 would then need to map the values into an order specific to a standardized format usable by the controls engine 206. In some embodiments, in converting the non-standardized data into the standardized data format, new data fields may be created whose values are derived from other data fields in the non-standardized data. For example, the standardized data format may have a “region” field, in which a region includes various counties. The non-standardized data of a particular computing service 202 may include a country field, but not the “region” field used by the controls engine 206. Thus, the conversion for this computing service 202 would include a mapping between each country value the region to which it belongs, and the creation of a “region” field.

In some embodiments, the computing services 202 may employ other types of data structures and schemes for converting the non-standardized data format into a standardized data format usable by the controls engine 206 regardless of the originating computing service 202. Each computing service 202 has access to a mapping scheme specific to the computing service 202 that enables it to repackage the relevant data into the standardized format used by the controls engine 206. This may be more efficient than changing the naming conventions of the computing services 202 themselves because other processes downstream of specific computing services may also be configured to consume data in the original non-standardized format.

Thus, when the computing service 202 makes a call to the orchestrator 204, the information is converted into a standardized format and packaged for consumption by the controls engine 206. Thus, the request received at the orchestrator 204 includes a data package that includes attributes of the requested fund transfer in a standardized service-agnostic format.

The controls engine 206 analyzes the attributes in the data package to determine which policies the request is subject to and whether the requested fund transfer is compliant with the policies, and approves or reject the request accordingly. The controls engine 206 accesses a policy database 214 and filters for which policies are applicable to the request depending on one or more of the attributes of the request. Example attributes may include transfer amount, payment type, account type, geographic location, address, originating jurisdiction (e.g., country, state, province), destination jurisdiction, banking institution, product or service category, currencies, sender or recipient age, transfer frequency, among others.

For example, different policies may be applicable to fund transfers that are associated with different geography regions, jurisdictions, languages, currencies, transfer amounts, product sections, among others and in various combinations. For example, a certain policy may only apply to a fund transfer coming from a certain jurisdiction and having at least a certain value. In some embodiments, policies may be implemented as computational constraint expression that indicates the acceptable values of certain attributes. For example, a computational constraint expression may indicate that only transfers of less than a threshold amount coming from a certain country may be approved.

The controls engine 206 validates whether the attributes of the request satisfy the applicable policies. In some embodiments, the values of certain attributes of the fund transfer request must be within the acceptable values indicated by the constraint expression representing the policy. If the attributes do not satisfy the applicable policies, the request is rejected. In some embodiments, if more than one policy is applicable to the fund transfer, then all of the policies must be satisfied for the request to be approved. If the attributes do satisfy the applicable policies, the controls engine approves the request.

In some embodiments, the controls engine 206 returns a result of the validation to the orchestrator 204. If the validation result is successful, meaning the request is approved, a license tokening service 210 of the orchestrator 204 generates a license token. Various downstream functions may utilize the license token. For example, a confirmation service 212 of the orchestrator 204 makes a request or call to a fund transfer manager 208 to execute the fund transfer. In some embodiments, the fund transfer manager 208 governs the transfer of funds and requires a valid license token in order to execute a transfer.

The orchestrator 204 may send a request with the license token to the fund transfer manager 208 to execute the fund transfer. In some embodiments, this occurs automatically after obtaining the license token. In some embodiments, the orchestrator sends a response back to the requesting computing service 202 with the license token. Thus, the computing service 202 may make requests to the fund transfer manager 208 directly using the license token. In some embodiments, the license token may be securely stored and used by the computing service 202 at a later date. For example, a customer may make a purchase at a merchant system, and the purchase may trigger the above-described process to validate the associated transaction. However, the merchant system may be configured such that the customer is not charged until the product ships, which may be days after the purchase. When the product is shipped, the customer is then automatically charged. In this case, the corresponding computing service 202 for handling the transaction may obtain a license token at the time of the purchase and send a request with the license token to the fund transfer manage to execute the transfer of funds when the product is marked as shipped, which may be days later. Similarly, the license token may be used to request a transfer of funds for recurring payments.

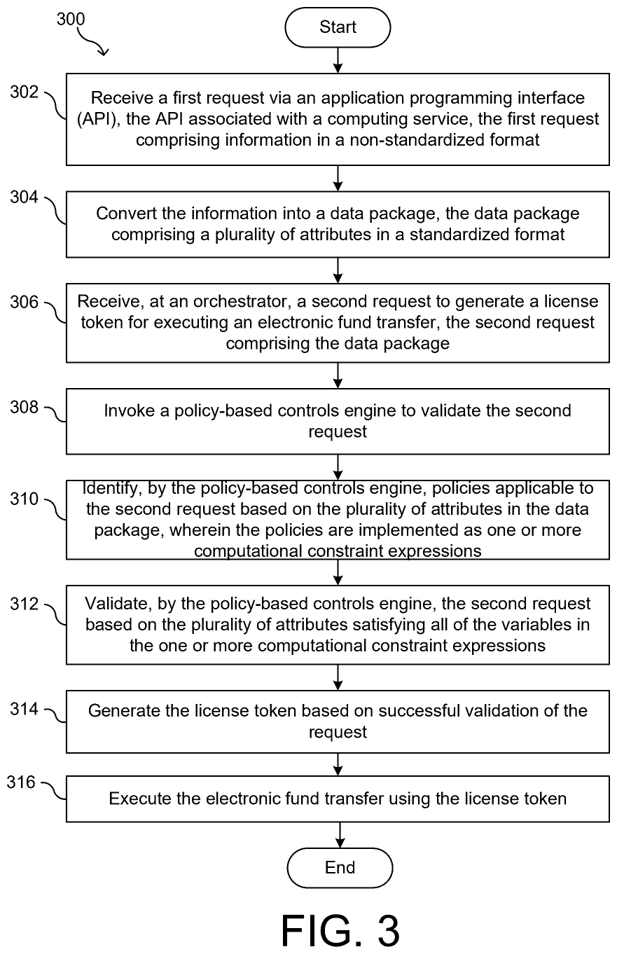

FIG. 3 depicts a flowchart of a method 300 for service-agnostic policy enforcement, according to an embodiment of the present disclosure. In some embodiments of the present disclosure, the operations of method 300 are performed by a computing environment 200 including one or more processing circuits and having instructions stored in one or more memories that, when executed by the one or more processing circuits, configure the computing system to implement service-agnostic policy enforcement as described herein. In some embodiments, the steps of method 300 may be performed in a different order than illustrated. One of more steps may be performed synchronously or asynchronously over various spans of time. The method 300 may also include more or fewer steps than illustrated.

In some embodiments, at step 302, a first request is received at a computing environment. The first request may be sent from merchant server via an application programming interface (API) that is associated with a particular computing service provided by the computing environment. The computing service may be one of a plurality of computing services provided by or associated with the computing environment. The plurality of computing services may perform different functions and are accessed via their unique corresponding APIs. Additionally, the computing services may have different API parameters which are structured in various and non-standardized formats with respect other computing systems in the computing environment. Thus, the first request may include information, such as parameters and attributes, in a non-standardized format. For example, in some embodiments, a first computing service of the plurality of computing services associated with the computing environment receives requests that include information in a first non-standardized format, and a second computing service of the plurality of computing services associated with the computing environment receives requests that include information in a second non-standardized format.

At step 304, the information in the first request is converted into a data package that includes a plurality of attributes in a standardized format. Thus, regardless of the type of computing service that is called by the first request of step 302, the relevant information (e.g., parameters, attributes) in the request is converted into the same standardized format for downstream processing.

At step 306, a second request is received at an orchestrator of the computing environment. In other words, a call is made to the orchestrator by the computing service. The second request or call is to generate a license token for executing an electronic fund transfer. The second request or call includes the data packages generated by the computing service which includes a plurality of attributes in the standardized format. Before issuing a license token, the orchestrator makes a call to a policy-based controls engine to validate that the request. In some embodiments, the orchestrator is implemented by instructions stored in memory and executed by a processing circuit of the computing environment.

At step 308, the policy-based controls engine is invoked to validate the second request. In some embodiments, the policy-based controls engine is automatically invoked immediately upon receiving any request to generate a license token associated with any of the plurality of computing services, so as to provide an automatic and near instantaneous validation of all fund transfer requests regardless of the originating computing service. This way, the validation process is an imperceptible part of the checkout process and the user experience is not degraded. As a part of the validation process, at step 310, the policy-based controls engine identifies, from a database of policies, one or more policies that are applicable to the second request based on one or more of the plurality of attributes in the data package. For example, different policies may be applicable to fund transfers that are associated with different geography regions, jurisdictions, languages, currencies, product sections, among other parameters. In some embodiments, the plurality of attributes may include one or more of the following: transfer amount, payment type, account type, geographic location, address, originating jurisdiction (e.g., country, state, province), destination jurisdiction, banking institution, product or service category, currencies, sender or recipient age, transfer frequency, among others.

At step 312 the policy-based controls engine validates the second request based on whether the plurality of attributes satisfy the one or more applicable policies. In some embodiments, a plurality of policies may be applicable. Thus, in order to satisfy the policies, the attributes must satisfy every one of the applicable policies. In other words, if one policy is not satisfied, then the validation fails.

At step 314, the license token is generated based on successful validation of the request. In other words, the license token is generated if the validation is successful, and the license token is not generated if the validation fails. After the license token is generated, it can be used in different ways, depending on the requesting computing service. In some embodiments, a fund transfer manager that governs confirmation and settlement of a transaction requires a valid license token in order to execute transfer of funds. Thus, at step 316, an electronic fund transfer is executed using the license token. In some embodiments, the request to the fund transfer manager is made by the orchestrator, such as directly after obtaining the license token.

In some embodiments, a response including the license token is sent from the orchestrator to the computing service in response to the second request. The computing service can call the fund transfer manager directly using the license token to execute a fund transfer. Thus, the fund transfer manager may receive a third request via the computing service to execute the electronic fund transfer, in which the third request includes a valid license token. In some embodiments, the fund transfer manager may receive a third request from the orchestrator to execute the electronic fund transfer, in which the third request includes a valid license token.

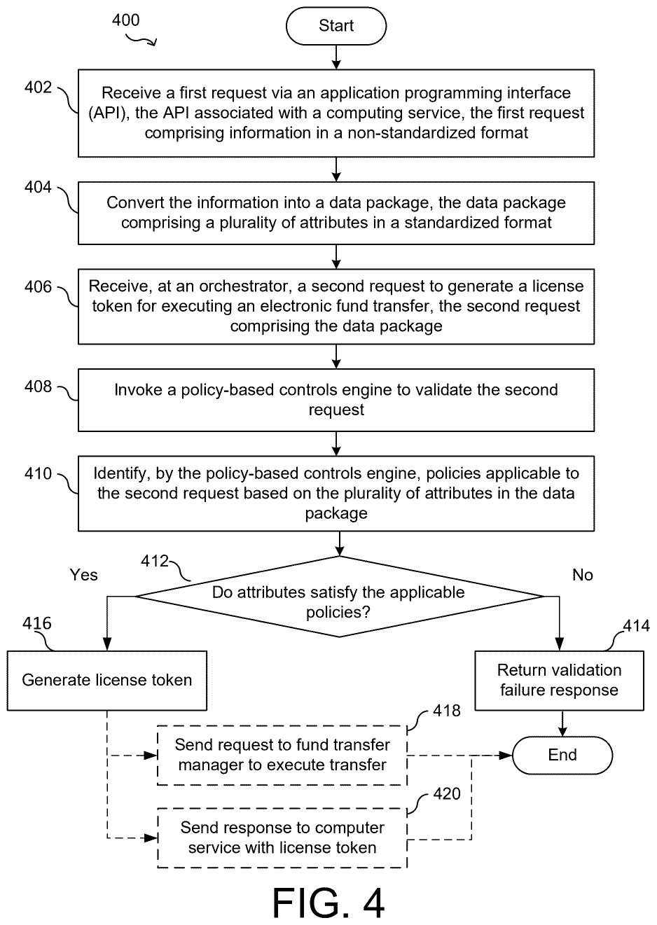

FIG. 4 depicts a flowchart of a method for service-agnostic policy enforcement illustrating multiple potential paths, according to an embodiment of the present disclosure. In some embodiments of the present disclosure, the operations of method 400 are performed by a computing environment 200 including one or more processing circuits and having instructions stored in one or more memories that, when executed by the one or more processing circuits, configure the computing system to implement service-agnostic policy enforcement as described herein. In some embodiments, the steps of method 400 may be performed in a different order than illustrate. One of more steps may be performed synchronously or asynchronously over various spans of time. The method 400 may be performed with more or fewer steps than illustrated.

At step 402, a first request is received at a computing environment. The first request may be sent from merchant server via an application programming interface (API) that is associated with a particular computing service provided by the computing environment. The particularly computing service may be one of a plurality of computing services provided by or associated with the computing environment. The plurality of computing services may perform different functions and are accessed via unique APIs and API endpoints. Additionally, the computing services may have different API parameters which are structured in various and non-standardized formats with respect to one another. Thus, the first request may include information, such as parameters and attributes, in a non-standardized format.

At step 404, the information in the first request is converted into a data package that includes a plurality of attributes in a standardized format. Thus, regardless of the type of computing service that is called by the first request of step 402, the relevant information (e.g., parameters, attributes) in the request is converted into the same standardized format for downstream processing.

At step 406, a second request is received at an orchestrator of the computing environment. In other words, a call is made to the orchestrator by the computing service. The second request or call is to generate a license token for executing an electronic fund transfer. The request or call includes the data packages generated by the computing service which includes a plurality of attributes in the standardized format. Before issuing a license token, the orchestrator makes a call to a policy-based controls engine to validate that the request.

At step 408, the policy-based controls engine is invoked to validate the second [0052] request. As a part of the validation process, at step 410, the policy-based controls engine identifies, from a database of policies, one or more policies that are applicable to the second request based on one or more of the plurality of attributes in the data package. For example, different policies may be applicable to fund transfers that are associated with different geography regions, jurisdictions, languages, currencies, product sections, among other parameters. In some embodiments, the one or more policies are implemented as one or more computational constraint expressions.

At step 412, a determination is made as to whether the attributes satisfy the applicable policies. In some embodiments, validating the second request includes the plurality of attributes satisfying all of the variables in the applicable computational constraint expressions. If the attributes do not satisfy the application policies, at step 414, a failure response is returned in response to the second request from the orchestrator and/or the first request from the merchant server. In some embodiments, a plurality of policies may be applicable. Thus, in order to satisfy the policies, the attributes must satisfy every one of the applicable policies. In other words, if one policy is not satisfied, then the validation fails. If the attributes satisfy the applicable policies, then at step 416, the license token is generated.

After the license token is generated, it can be used in different ways, depending on the requesting computing service and/or according to different embodiments and use cases. In some embodiments, a fund transfer manager that governs confirmation and settlement of a transaction requires a valid license token in order to execute the transfer of funds. In some embodiments, the orchestrator makes a request to the fund transfer manager to execute the fund transfer. At step 418, the orchestrator sends a request with the license token to the fund transfer manager to execute the fund transfer. In some embodiments, this occurs automatically after obtaining the license token. In some embodiments, at step 420, the orchestrator sends a response to the computing service with the license token such that the computing service may make requests to the fund transfer manager directly using the license token. In some embodiments, the license token may be securely stored and used by the computing service at a later date.

In some embodiments, the method 400 further includes creating or updating a record of the first or second request in a database, the record including one or more tags selected based at least in part on the one or more policies.

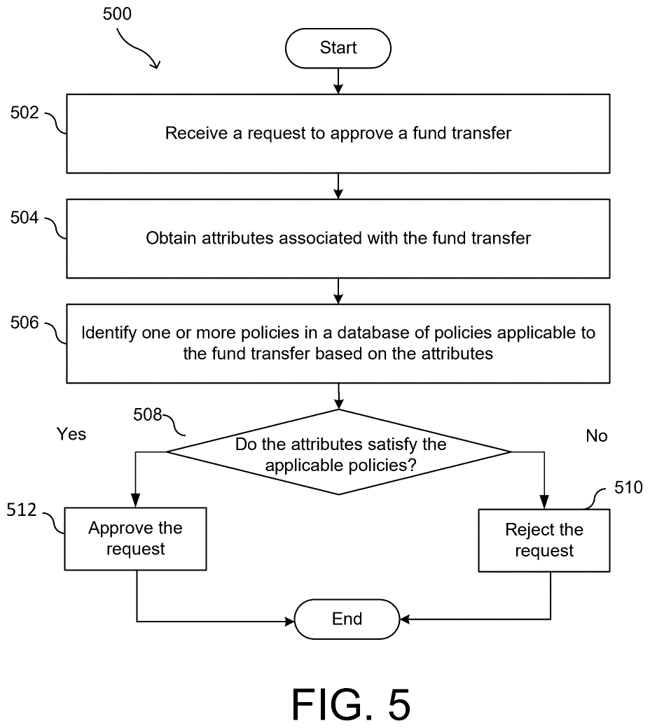

FIG. 5 depicts a flowchart of a method for service-agnostic policy enforcement, according to one embodiment of the present disclosure. In some embodiments of the present disclosure, the operations of method 500 are performed by a computing environment 200 including one or more processing circuits and having instructions stored in one or more memories that, when executed by the one or more processing circuits, configure the computing system to implement service-agnostic policy enforcement as described herein. In some embodiments, the steps of method 500 may be performed in a different order than illustrate. One of more steps may be performed synchronously or asynchronously over various spans of time.

At step 502, a request to approve a fund transfer is received at a policy-based controls engine of a computing environment. The policy-based controls engine may be a microservice in a stack of microservices implemented in the computing environment to carry out various combinations of computing tasks. In some embodiments, an orchestrator may route or send the request to the policy-based controls engine. The request may include a plurality of attributes associated with the fund transfer. In some embodiments, the request may be associated with a specific computing service (e.g., microservice) among many computing services provided by the computing environment.

At step 504, the attributes associated with the fund transfer are obtained and used to validate the request. For example, the attributes may include transfer amount, payment type, account type, geographic location, address, originating jurisdiction (e.g., country, state, province), destination jurisdiction, banking institution, product or service category, currencies, sender or recipient age, transfer frequency, among others. At step 506, one or more policies that are applicable to the requested fund transfer are identified from a database of policies. For example, different policies may be applicable to fund transfers that are associated with different geography regions, jurisdictions, languages, currencies, product sections, among others and in various combination. For example, a certain policy may only apply to a fund transfer coming from a certain jurisdiction and having at least a certain value. In some embodiments, a policy may be implemented as a constraint expression that indicates the acceptable values of certain attributes. At step 508, it is determined whether the attributes satisfy the applicable policies. In some embodiments, the values of certain attributes of the fund transfer must be within the acceptable values indicated by the constraint expression representing the policy. If the attributes do not satisfy the applicable policies, at step 510, the request is rejected. In some embodiments, if more than one policy is applicable to the fund transfer, then all of the policies much be satisfied for the request to be approved. If the attributes do satisfy the applicable policies, at step 512, the request is approved.

In some embodiments, when the request is approved, a response is sent to the requestor indicating the approval or rejection. In some embodiments, the policy-based controls engine may trigger a subsequent action upon the approval or rejection. For example, the policy-based controls engine may call a fund transfer manager to initiate the transfer of funds upon approval of the request. In some embodiments, the policy-based controls engine may trigger a notification or tagging event upon a rejection so that the rejection can be flagged for further review.

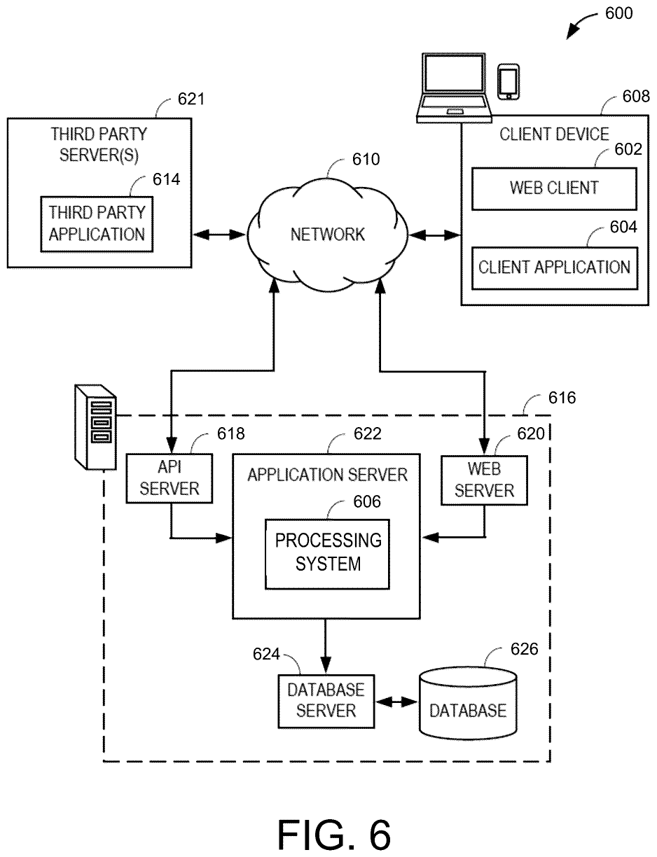

With reference to FIG. 6, an example embodiment of a high-level SaaS network architecture 600 is shown. A networked system 616 provides server-side functionality via a network 610 (e.g., the Internet or a WAN) to a client device 608. A web client 602 and a programmatic client, in the example form of a client application 604 (e.g., client software for providing or accessing the user interface 127 of the services processing system 104a with policy-based controls engine 206, are hosted and execute on the client device 608. The networked system 616 includes one or more servers 622 (e.g., servers hosting services exposing remote procedure call APIs), which hosts a processing system 606 (such as the processing system described above according to various embodiments of the present disclosure supporting service for automatically processing accounting data) that provides a number of functions and services via a service oriented architecture (SOA) and that exposes services to the client application 604 that accesses the networked system 616 where the services may correspond to particular workflows. The client application 604 also provides a number of interfaces described herein, which can present an output in accordance with the methods described herein to a user of the client device 608.

The client device 608 enables a user to access and interact with the networked system 616 and, ultimately, the processing system 606. For instance, the user provides input (e.g., touch screen input or alphanumeric input) to the client device 608, and the input is communicated to the networked system 616 via the network 610. In this instance, the networked system 616, in response to receiving the input from the user, communicates information back to the client device 608 via the network 610 to be presented to the user.

An API server 618 and a web server 620 are coupled, and provide programmatic and web interfaces respectively, to the servers 622. For example, the API server 618 and the web server 620 may produce messages (e.g., RPC calls) in response to inputs received via the network, where the messages are supplied as input messages to workflows orchestrated by the processing system 606. The API server 618 and the web server 620 may also receive return values (return messages) from the processing system 606 and return results to calling parties (e.g., web clients 602 and client applications 604 running on client devices 608 and third-party applications 614) via the network 610. The servers 622 host the processing system 606, which includes components or applications in accordance with embodiments of the present disclosure as described above. The servers 622 are, in turn, shown to be coupled to one or more database servers 624 that facilitate access to information storage repositories (e.g., databases 626). In an example embodiment, the databases 626 includes storage devices that store information accessed and generated by the processing system 606, such as the policies of policy database 214 and other databases such as databases storing information associated with transactions processed by a business.

Additionally, a third-party application 614, executing on one or more third-party servers 621, is shown as having programmatic access to the networked system 616 via the programmatic interface provided by the API server 618. For example, the third-party application 614, using information retrieved from the networked system 616, may support one or more features or functions on a website hosted by a third-party. For example, the third-party application 614 may serve as a data source for retrieving, for example, historical transaction data 121.

Turning now specifically to the applications hosted by the client device 608, the web client 602 may access the various systems (e.g., the processing system 606) via the web interface supported by the web server 620. Similarly, the client application 604 (e.g., an “app”) may access the various services and functions provided by the processing system 606 via the programmatic interface provided by the API server 618. The client application 604 may be, for example, an “app” executing on the client device 608, such as an iOS or Android OS application to enable a user to access and input data on the networked system 616 in an offline manner and to perform batch-mode communications between the client application 604 and the networked system 616.

Further, while the network architecture 600 shown in FIG. 6 employs a client-server architecture, the present disclosure is not limited to such an architecture, and could equally well find application in a distributed, or peer-to-peer, architecture system, for example.

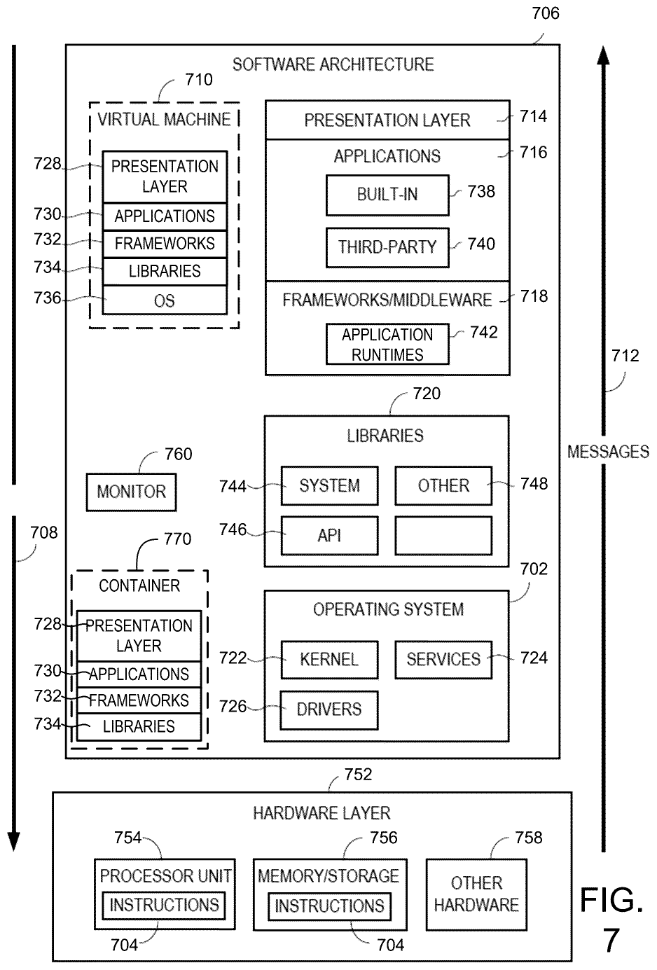

FIG. 7 is a block diagram illustrating an example software architecture 706, which may be used in conjunction with various hardware architectures herein described. FIG. 7 is a non-limiting example of a software architecture 706, and it will be appreciated that many other architectures may be implemented to facilitate the functionality described herein. The software architecture 706 may execute on hardware such as a machine 800 of FIG. 8 that includes, among other things, processors 804, memory/storage 806, and input/output (I/O) components 818. A representative hardware layer 752 is illustrated and can represent, for example, the machine 800 of FIG. 8. The representative hardware layer 752 includes a processor 754 having associated executable instructions 704. The executable instructions 704 represent the executable instructions of the software architecture 706, including implementation of the methods, components, and so forth described herein. The hardware layer 752 also includes non-transitory memory and/or storage modules as memory/storage 756, which also have the executable instructions 704. The hardware layer 752 may also include other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716 (such as the services of services processing system 104a with policy-based controls engine 206), and a presentation layer 714. Operationally, the applications 716 and/or other components within the layers may invoke API calls 708 through the software stack and receive a response as messages 712 in response to the API calls 708. The layers illustrated are representative in nature, and not all software architectures have all layers. For example, some mobile or special-purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 provide a common infrastructure that is used by the applications 716 and/or other components and/or layers. The libraries 720 provide functionality that allows other software components to perform tasks in an easier fashion than by interfacing directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 720 may also include a wide variety of other libraries 748 to provide many other APIs to the applications 716 and other software components/modules.

The frameworks/middleware 718 provide a higher-level common infrastructure that may be used by the applications 716 and/or other software components/modules. For example, the frameworks/middleware 718 may provide high-level resource management functions, web application frameworks, application runtimes 742 (e.g., a Java virtual machine or JVM), and so forth. The frameworks/middleware 718 may provide a broad spectrum of other APIs that may be utilized by the applications 716 and/or other software components/modules, some of which may be specific to a particular operating system or platform.

The applications 716 include built-in applications 738 and/or third-party applications 740. The applications 716 may use built-in operating system functions (e.g., kernel 722, services 724, and/or drivers 726), libraries 720, and frameworks/middleware 718 to create user interfaces to interact with users of the system. Alternatively, or additionally, in some systems, interactions with a user may occur through a presentation layer, such as the presentation layer 714. In these systems, the application/component “logic” can be separated from the aspects of the application/component that interact with a user.

Some software architectures use virtual machines. In the example of FIG. 7, this is illustrated by a virtual machine 710. The virtual machine 710 creates a software environment where applications/components can execute as if they were executing on a hardware machine (such as the machine 800 of FIG. 8, for example). The virtual machine 710 is hosted by a host operating system (e.g., the operating system 702 in FIG. 7) and typically, although not always, has a virtual machine monitor 760 (or hypervisor), which manages the operation of the virtual machine 710 as well as the interface with the host operating system (e.g., the operating system 702). A software architecture executes within the virtual machine 710 such as an operating system (OS) 736, libraries 734, frameworks 732, applications 730, and/or a presentation layer 728. These layers of software architecture executing within the virtual machine 710 can be the same as corresponding layers previously described or may be different.

Some software architectures use containers 770 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 770 is similar to a virtual machine in that it includes a software architecture including libraries 734, frameworks 732, applications 730, and/or a presentation layer 728, but omits an operating system and, instead, communicates with the underlying host operating system 702.

According to one embodiment of the present disclosure, a method includes receiving, at a computing environment, a first request from a merchant server via an application programming interface (API), the API associated with a computing service of a plurality of computing services associated with the computing environment, the first request comprising information in a non-standardized format; converting, by a server in the computing environment, the information into a data package, the data package comprising a plurality of attributes in a standardized format; receiving, at an orchestrator in the computing environment, a second request to generate a license token for executing an action, the second request comprising the data package; invoking a policy-based controls engine in the computing environment to validate the second request, wherein the policy-based controls engine is automatically invoked upon receiving any request to generate a license token associated with any of the plurality of computing services; identifying, by the policy-based controls engine, one or more policies applicable to the second request based on one or more of the plurality of attributes in the data package, wherein the one or more policies are implemented as one or more computational constraint expressions; validating, by the policy-based controls engine, the second request based on the plurality of attributes satisfying each of the one or more computational constraint expressions, generating the license token based on successful validation of the second request; and executing the action using the license token.

In some embodiments, a first computing service of the plurality of computing services associated with the computing environment receives requests comprises information in a first non-standardized format, and a second computing service of the plurality of computing services associated with the computing environment receives requests comprises information in a second non-standardized format different from the first non-standardized format. In some embodiments, the method further includes sending, by the orchestrator to the computing service, a response to the second request, the response comprising the license token. In some embodiments, the method further includes receiving a third request via the computing service to execute the action, the third request comprising the license token. In some embodiments, the method further includes receiving a third request from the orchestrator to execute the action, the third request comprising the license token. In some embodiments, validating the second request includes the plurality of attributes satisfying all of the variables in each of the one or more computational constraint expressions. In some embodiments, the method further includes creating or updating a record of the first or second request in a database, the record including one or more tags selected based at least in part on the one or more policies.

According to another embodiment of the present disclosure, a system includes: a processor; and memory storing instructions that, when executed by the processor, cause the processor to: receive, at a computing environment, a first request from a merchant server via an application programming interface (API), the API associated with a computing service of a plurality of computing services associated with the computing environment, the first request comprising information in a non-standardized format; convert, by a server in the computing environment, the information into a standardized format; receive, at an orchestrator in the computing environment, a second request to generate a license token for executing an action, the second request comprising the information in the standardized formal; invoke a policy-based controls engine in the computing environment to validate the second request, wherein the policy-based controls engine is automatically invoked upon receiving any request to generate a license token associated with any of the plurality of computing services; identify, by the policy-based controls engine, one or more policies applicable to the second request based on one or more of the plurality of attributes in the information in the standardized format, wherein the one or more policies are implemented as one or more computational constraint expressions; validate or deny, by the policy-based controls engine, the second request based on whether the plurality of attributes satisfy the one or more policies; generate a response based on whether the second request was validated or denied; and transmit the response to the orchestrator.

In some embodiments, a first computing service of the plurality of computing services associated with the computing environment receives requests comprising information in a first non-standardized format; and a second computing service of the plurality of computing services associated with the computing environment receives requests comprising information in a second non-standardized format. In some embodiments, the instructions, when executed by the processor, further cause the processor to validate the second request; generate a license token; and send, by the orchestrator, the license token in response to the second request. In some embodiments, the instructions, when executed by the processor, further cause the processor to receive a third request via the computing service to execute the action, the third request comprising the license token. In some embodiments, the instructions, when executed by the processor, further cause the processor to validate the second request; generate a license token; and receive a third request from the orchestrator to execute the action, the third request comprising the license token. In some embodiments, validating the second request includes the plurality of attributes satisfying each of the one or more policies. In some embodiments, the instructions, when executed by the processor, further cause the processor to create or update a record of the first or second request in a database, the record including one or more tags selected based at least in part on the one or more policies.

According to another embodiment of the present disclosure, a non-transitory computer-readable medium storing instructions that, when executed by a processor, cause the processor to: receive, at a computing environment, a first request from a merchant server via an application programming interface (API), the API associated with a computing service of a plurality of computing services associated with the computing environment, the first request comprising information in a non-standardized format; convert, by a server in the computing environment, the information into a data package, the data package comprising a plurality of attributes in a standardized format; receive, at an orchestrator in the computing environment, a second request to generate a license token for executing an action, the second request comprising the data package; invoke a policy-based controls engine in the computing environment to validate the second request; identify, by the policy-based controls engine, one or more policies applicable to the second request based on one or more of the plurality of attributes in the data package, wherein the one or more policies are implemented as one or more computational constraint expressions; validate, by the policy-based controls engine, the second request based on the plurality of attributes satisfying the one or more policies; generate the license token based on successful validation of the second request; and execute the action using the license token.

In some embodiments, a first computing service of the plurality of computing services associated with the computing environment receives requests comprising information in a first non-standardized format; and a second computing service of the plurality of computing services associated with the computing environment receives requests comprising information in a second non-standardized format. In some embodiments, the non-transitory computer-readable medium further comprising instructions that, when executed by the processor, cause the processor to send, by the orchestrator to the computing service, a response to the second request, the response comprising the license token. In some embodiments, the non-transitory computer-readable medium further comprising instructions that, when executed by the processor, cause the processor to receive a third request via the computing service to execute the action, the third request comprising the license token. In some embodiments, the non-transitory computer-readable medium further comprising instructions that, when executed by the processor, cause the processor to receive a third request from the orchestrator to execute the action, the third request comprising the license token. In some embodiments, validating the second request includes the plurality of attributes satisfying each of the one or more policies.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method comprising:
receiving, at a computing environment, a first request from a merchant server via an application programming interface (API), the API associated with a computing service of a plurality of computing services associated with the computing environment, the first request comprising information in a non-standardized format;
converting, by a server in the computing environment, the information into a data package, the data package comprising a plurality of attributes in a standardized format;
receiving, at an orchestrator in the computing environment, a second request to generate a license token for executing an action, the second request comprising the data package;
invoking a policy-based controls engine in the computing environment to validate the second request, wherein the policy-based controls engine is automatically invoked upon receiving any request to generate a license token associated with any of the plurality of computing services;
identifying, by the policy-based controls engine, one or more policies applicable to the second request based on one or more of the plurality of attributes in the data package, wherein the one or more policies are implemented as one or more computational constraint expressions;
validating, by the policy-based controls engine, the second request based on the plurality of attributes satisfying each of the one or more computational constraint expressions;
generating the license token based on successful validation of the second request; and
executing action using the license token.

2. The method of claim 1, wherein:
a first computing service of the plurality of computing services associated with the computing environment receives requests comprises information in a first non-standardized format; and
a second computing service of the plurality of computing services associated with the computing environment receives requests comprises information in a second non-standardized format different from the first non-standardized format.

3. The method of claim 1, further comprising:
sending, by the orchestrator to the computing service, a response to the second request, the response comprising the license token.

4. The method of claim 3, further comprising:
receiving a third request via the computing service to execute the action, the third request comprising the license token.

5. The method of claim 1, further comprising:
receiving a third request from the orchestrator to execute the action, the third request comprising the license token.

6. The method of claim 1, wherein validating the second request includes the plurality of attributes satisfying all of the variables in each of the one or more computational constraint expressions.

7. The method of claim 1, further comprising:
creating or updating a record of the first or second request in a database, the record including one or more tags selected based at least in part on the one or more policies.

8. A system comprising:
a processor; and
memory storing instructions that, when executed by the processor, cause the processor to:
receive, at a computing environment, a first request from a merchant server via an application programming interface (API), the API associated with a computing service of a plurality of computing services associated with the computing environment, the first request comprising information in a non-standardized format;
convert, by a server in the computing environment, the information into a standardized format;
receive, at an orchestrator in the computing environment, a second request to generate a license token for executing an action, the second request comprising the information in the standardized formal;
invoke a policy-based controls engine in the computing environment to validate the second request, wherein the policy-based controls engine is automatically invoked upon receiving any request to generate a license token associated with any of the plurality of computing services;
identify, by the policy-based controls engine, one or more policies applicable to the second request based on one or more of the plurality of attributes in the information in the standardized format, wherein the one or more policies are implemented as one or more computational constraint expressions;
validate or deny, by the policy-based controls engine, the second request based on whether the plurality of attributes satisfy the one or more policies;
generate a response based on whether the second request was validated or denied; and
transmit the response to the orchestrator.

9. The system of claim 8, wherein:
a first computing service of the plurality of computing services associated with the computing environment receives requests comprising information in a first non-standardized format; and
a second computing service of the plurality of computing services associated with the computing environment receives requests comprising information in a second non-standardized format.

10. The system of claim 8, wherein the instructions, when executed by the processor, further cause the processor to:
validate the second request;
generate a license token; and
send, by the orchestrator, the license token in response to the second request.

11. The system of claim 10, wherein the instructions, when executed by the processor, further cause the processor to:
receive a third request via the computing service to execute the action, the third request comprising the license token.

12. The system of claim 8, wherein the instructions, when executed by the processor, further cause the processor to:
validate the second request;
generate a license token; and
receive a third request from the orchestrator to execute the action, the third request comprising the license token.

13. The system of claim 8, wherein validating the second request includes the plurality of attributes satisfying each of the one or more policies.

14. The system of claim 8, wherein the instructions, when executed by the processor, further cause the processor to:
create or update a record of the first or second request in a database, the record including one or more tags selected based at least in part on the one or more policies.

15. A non-transitory computer-readable medium storing instructions that, when executed by a processor, cause the processor to:
receive, at a computing environment, a first request from a merchant server via an application programming interface (API), the API associated with a computing service of a plurality of computing services associated with the computing environment, the first request comprising information in a non-standardized format;
convert, by a server in the computing environment, the information into a data package, the data package comprising a plurality of attributes in a standardized format;
receive, at an orchestrator in the computing environment, a second request to generate a license token for executing an action, the second request comprising the data package;
invoke a policy-based controls engine in the computing environment to validate the second request;
identify, by the policy-based controls engine, one or more policies applicable to the second request based on one or more of the plurality of attributes in the data package, wherein the one or more policies are implemented as one or more computational constraint expressions;
validate, by the policy-based controls engine, the second request based on the plurality of attributes satisfying the one or more policies;
generate the license token based on successful validation of the second request; and
execute the action using the license token.

16. The non-transitory computer-readable medium of claim 15, wherein:
a first computing service of the plurality of computing services associated with the computing environment receives requests comprising information in a first non-standardized format; and
a second computing service of the plurality of computing services associated with the computing environment receives requests comprising information in a second non-standardized format.

17. The non-transitory computer-readable medium of claim 15, further comprising instructions that, when executed by the processor, cause the processor to:
send, by the orchestrator to the computing service, a response to the second request, the response comprising the license token.

18. The non-transitory computer-readable medium of claim 17, further comprising instructions that, when executed by the processor, cause the processor to:
receive a third request via the computing service to execute the action, the third request comprising the license token.

19. The non-transitory computer-readable medium of claim 15, further comprising instructions that, when executed by the processor, cause the processor to:
receive a third request from the orchestrator to execute the action, the third request comprising the license token.

20. The non-transitory computer-readable medium of claim 15, wherein validating the second request includes the plurality of attributes satisfying each of the one or more policies.
